(19) United States
(12) Patent Application Publication
(10) Pub. No.: US 2017/0310717 A1
(43) Pub. Date: Oct. 26, 2017

(54) SYSTEM AND METHOD FOR INSTANTIATING A HIDDEN SECONDARY CHAT SESSION FOR A PRIMARY CHAT SESSION

(71) Applicant: Hey There, LLC, North Grafton, MA (US)

(72) Inventors: Todd P. Staples, North Grafton, MA (US); Chad M. Huesgen, Westford, MA (US); Pradeep Arumbakkam, Needham, MA (US); Kevin P. Trainor, Princeton, MA (US)

(21) Appl. No.: 15/492,380

(22) Filed: Apr. 20, 2017

Related U.S. Application Data
(60) Provisional application No. 62/326,250, filed on Apr. 22, 2016.

(51) Int. Cl. H04L 29/06; H04L 12/58

(52) U.S. Cl. CPC H04L 65/4015; H04L 51/04

(57) ABSTRACT

A method, computer program product, and computer system for identifying a first message sent between a first user computing device and a second user computing device. A primary chat thread may be generated between the first user computing device and the second user computing device, wherein the primary chat thread may include the first message. A state of one or more attributes of the primary chat thread displayed on a graphical user interface on the first user computing device may be identified. A second message sent between the first user computing device and the second user computing device in the primary chat thread may be identified. The second message may be streamed over a network to a secondary chat thread between the first user computing device and a third user computing device when the state of the one or more attributes of the primary chat thread is in a first state. The second message sent between the first user computing device and the second user computing device in the primary chat thread may be transmitted without streaming the second message to the secondary chat thread between the first user computing device and the third user computing device when the state of the one or more attributes of the primary chat thread is in a second state.

### RELATED CASES

This application claims the benefit of U.S. Provisional Application No. 62/326,250 filed on 22 Apr. 2016, the content of which is all incorporated by reference.

### BACKGROUND

Generally, textual chat communications (e.g., instant messaging, chat rooms, text messaging, etc.) may be used to quickly and efficiently communicate with multiple people. In some situations, participants of, e.g., a chat group in a primary chat session, may wish to discuss what is transpiring in the primary chat session with a set of individuals that are not involved in the primary chat session. For instance, the individuals may wish to gather advice from friends on how to proceed (e.g., what to say) in the primary chat session, or they may wish for other members of their network or team to see the messages being exchanged for legal, quality assurance, training, etc.

### BRIEF SUMMARY OF DISCLOSURE

In one example implementation, a method, performed by one or more computing devices, may include but is not limited to identifying a first message sent between a first user computing device and a second user computing device. A primary chat thread may be generated between the first user computing device and the second user computing device, wherein the primary chat thread may include the first message. A state of one or more attributes of the primary chat thread displayed on a graphical user interface on the first user computing device may be identified. A second message sent between the first user computing device and the second user computing device in the primary chat thread may be identified. The second message may be streamed over a network to a secondary chat thread between the first user computing device and a third user computing device when the state of the one or more attributes of the primary chat thread is in a first state. The second message sent between the first user computing device and the second user computing device in the primary chat thread may be transmitted without streaming the second message to the secondary chat thread between the first user computing device and the third user computing device when the state of the one or more attributes of the primary chat thread is in a second state.

One or more of the following example features may be included. A selection of at least one of the first state and the second state on the graphical user interface displayed on the first user computing device may be received. The second user computing device may be a non-participant in the secondary chat thread and wherein the third user computing device may be a non-participant in the primary chat thread. A selection on the graphical user interface displayed on the first user computing device to switch between displaying the primary chat thread and the secondary chat thread may be received. An association table mapping the primary chat thread and the secondary chat thread may be generated. An entry in the association table mapping the primary chat thread and the secondary chat thread may be generated. Identifying the state of the one or more attributes of the primary chat thread displayed on the graphical user interface on the first user computing device may include marking the entry in the association table to identify whether streaming the second message to the secondary chat thread between the first user computing device and the third user computing device is enabled.

In another example implementation, a computing system may include one or more processors and one or more memories configured to perform operations that may include but are not limited to identifying a first message sent between a first user computing device and a second user computing device. A primary chat thread may be generated between the first user computing device and the second user computing device, wherein the primary chat thread may include the first message. A state of one or more attributes of the primary chat thread displayed on a graphical user interface on the first user computing device may be identified. A second message sent between the first user computing device and the second user computing device in the primary chat thread may be identified. The second message may be streamed over a network to a secondary chat thread between the first user computing device and a third user computing device when the state of the one or more attributes of the primary chat thread is in a first state. The second message sent between the first user computing device and the second user computing device in the primary chat thread may be transmitted without streaming the second message to the secondary chat thread between the first user computing device and the third user computing device when the state of the one or more attributes of the primary chat thread is in a second state.

One or more of the following example features may be included. A selection of at least one of the first state and the second state on the graphical user interface displayed on the first user computing device may be received. The second user computing device may be a non-participant in the secondary chat thread and wherein the third user computing device may be a non-participant in the primary chat thread. A selection on the graphical user interface displayed on the first user computing device to switch between displaying the primary chat thread and the secondary chat thread may be received. An association table mapping the primary chat thread and the secondary chat thread may be generated. An entry in the association table mapping the primary chat thread and the secondary chat thread may be generated. Identifying the state of the one or more attributes of the primary chat thread displayed on the graphical user interface on the first user computing device may include marking the entry in the association table to identify whether streaming the second message to the secondary chat thread between the first user computing device and the third user computing device is enabled.

In another example implementation, a computer program product may reside on a computer readable storage medium having a plurality of instructions stored thereon which, when executed across one or more processors, may cause at least a portion of the one or more processors to perform operations that may include but are not limited to identifying a first message sent between a first user computing device and a second user computing device. A primary chat thread may be generated between the first user computing device and the second user computing device, wherein the primary chat thread may include the first message. A state of one or more attributes of the primary chat thread displayed on a graphical user interface on the first user computing device may be identified. A second message sent between the first user computing device and the second user computing device in the primary chat thread may be identified. The second message may be streamed over a network to a secondary chat thread between the first user computing device and a third user computing device when the state of the one or more attributes of the primary chat thread is in a first state. The second message sent between the first user computing device and the second user computing device in the primary chat thread may be transmitted without streaming the second message to the secondary chat thread between the first user computing device and the third user computing device when the state of the one or more attributes of the primary chat thread is in a second state.

One or more of the following example features may be included. A selection of at least one of the first state and the second state on the graphical user interface displayed on the first user computing device may be received. The second user computing device may be a non-participant in the secondary chat thread and wherein the third user computing device may be a non-participant in the primary chat thread. A selection on the graphical user interface displayed on the first user computing device to switch between displaying the primary chat thread and the secondary chat thread may be received. An association table mapping the primary chat thread and the secondary chat thread may be generated. An entry in the association table mapping the primary chat thread and the secondary chat thread may be generated. Identifying the state of the one or more attributes of the primary chat thread displayed on the graphical user interface on the first user computing device may include marking the entry in the association table to identify whether streaming the second message to the secondary chat thread between the first user computing device and the third user computing device is enabled.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a secondary chat process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a secondary chat process according to one or more example implementations of the disclosure;

FIG. 4 is an example diagrammatic view of a screen image displayed by a secondary chat process according to one or more example implementations of the disclosure;

FIG. 5 is an example diagrammatic view of a screen image displayed by a secondary chat process according to one or more example implementations of the disclosure;

FIG. 6 is an example diagrammatic view of a screen image displayed by a secondary chat process according to one or more example implementations of the disclosure;

FIG. 7 is an example diagrammatic view of association tables used by a secondary chat process according to one or more example implementations of the disclosure;

FIG. 8 is an example diagrammatic view of a screen image displayed by a secondary chat process according to one or more example implementations of the disclosure; and

FIG. 9 is an example diagrammatic view of a screen image displayed by a secondary chat process according to one or more example implementations of the disclosure.

Like reference symbols in the various drawings indicate like elements.

### DETAILED DESCRIPTION

### System Overview:

In some implementations, as will be discussed below, the present disclosure may include a control method for chat groups that may allow users to instantiate secondary chat sessions as subsidiaries of a pre-existing primary chat session, whereas messages from the primary chat session of interest may be streamed to the secondary session(s), and where the other participants in the primary session may or may not have any knowledge of the existence of the private secondary session(s). In some implementations, all participants in the primary chat session may be able to instantiate their own secondary chat group(s), invite whomever they like into it (even those not included/participating in the primary chat session), and turn on or off streaming such that some or all messages in the primary chat session may be streamed to the secondary chat session for those participants of the secondary chat session to see and discuss. In some implementations, any users may be invited to the secondary chat sessions including other primary chat participants, as well as users who are not previously involved in the participating in the primary chat session. In some implementations, any participants of the secondary chat sessions may remove themselves from the secondary chat sessions if they no longer wish to be involved. In some implementations, the creator of the secondary chat session may remove participants of the secondary chat session if the creator no longer wishes them to be involved. In some implementations, the creator of the secondary chat session may end the secondary chat session if they do not wish for it to be available any longer.

In some implementations, the present disclosure may be embodied as a computer method, computer system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

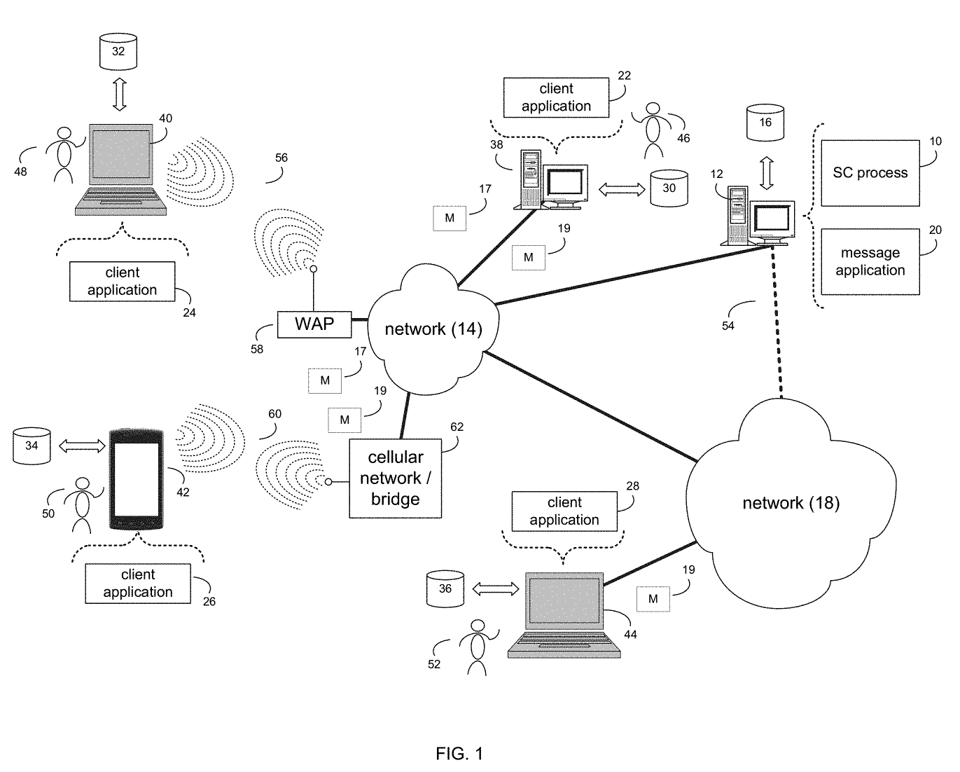

Referring now to the example implementation of FIG. 1, there is shown secondary chat (SC) process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a SC process, such as SC process 10 of FIG. 1, may identify a first message (e.g., message 17) sent between a first user computing device and a second user computing device. A primary chat thread may be generated between the first user computing device and the second user computing device, wherein the primary chat thread may include the first message. A state of one or more attributes of the primary chat thread displayed on a graphical user interface on the first user computing device may be identified. A second message (e.g., message 19) sent between the first user computing device and the second user computing device in the primary chat thread may be identified. The second message may be streamed over a network to a secondary chat thread between the first user computing device and a third user computing device when the state of the one or more attributes of the primary chat thread is in a first state. The second message sent between the first user computing device and the second user computing device in the primary chat thread may be transmitted without streaming the second message to the secondary chat thread between the first user computing device and the third user computing device when the state of the one or more attributes of the primary chat thread is in a second state.

In some implementations, the instruction sets and subroutines of SC process 10, which may be stored on storage device, such as storage device 16, coupled to computer 12, may be executed by one or more processors and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, MySQL, PostgreSQL, Oracle, Microsoft SQL Server and/or IBM DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, SC process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a message application (e.g., message application 20), examples of which may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, social network application, dating application, or other application that allows for virtual messaging and/or remote messaging over a network. In some implementations, SC process 10 and/or message application 20 may be accessed via one or more of client applications 22, 24, 26, 28. In some implementations, SC process 10 may be a standalone application, or may be an applet/application/script/extension that may interact with and/or be executed within message application 20, a component of message application 20, and/or one or more of client applications 22, 24, 26, 28. In some implementations, message application 20 may be a standalone application, or may be an applet/application/script/extension that may interact with and/or be executed within SC process 10, a component of SC process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of SC process 10 and/or message application 20. Examples of client applications 22, 24, 26, 28 may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, social network application, dating application, or other application that allows for virtual messaging and/or remote messaging over a network, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM).

Examples of client electronic devices 38, 40, 42, 44 (and/or computer 12) may include, but are not limited to, a personal computer (e.g., client electronic device 38), a laptop computer (e.g., client electronic device 40), a smart/data-enabled cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of SC process 10 (and vice versa). Accordingly, in some implementations, SC process 10 may be a purely server-side application, a purely client-side application, or a hybrid server-side/client-side application that is cooperatively executed by one or more of client applications 22, 24, 26, 28 and/or SC process 10.

In some implementations, one or more of client applications 22, 24, 26, 28 may be configured to effectuate some or all of the functionality of message application 20 (and vice versa). Accordingly, in some implementations, message application 20 may be a purely server-side application, a purely client-side application, or a hybrid server-side/client-side application that is cooperatively executed by one or more of client applications 22, 24, 26, 28 and/or message application 20. As one or more of client applications 22, 24, 26, 28, SC process 10, and message application 20, taken singly or in any combination, may effectuate some or all of the same functionality, any description of effectuating such functionality via one or more of client applications 22, 24, 26, 28, SC process 10, message application 20, or combination thereof, and any described interaction(s) between one or more of client applications 22, 24, 26, 28, SC process 10, message application 20, or combination thereof to effectuate such functionality, should be taken as an example only and not to limit the scope of the disclosure.

In some implementations, one or more of users 46, 48, 50, 52 may access computer 12 and SC process 10 (e.g., using one or more of client electronic devices 38, 40, 42, 44) directly through network 14 or through secondary network 18. Further, computer 12 may be connected to network 14 through secondary network 18, as illustrated with phantom link line 54. SC process 10 may include one or more user interfaces, such as browsers and textual or graphical user interfaces, through which users 46, 48, 50, 52 may access SC process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

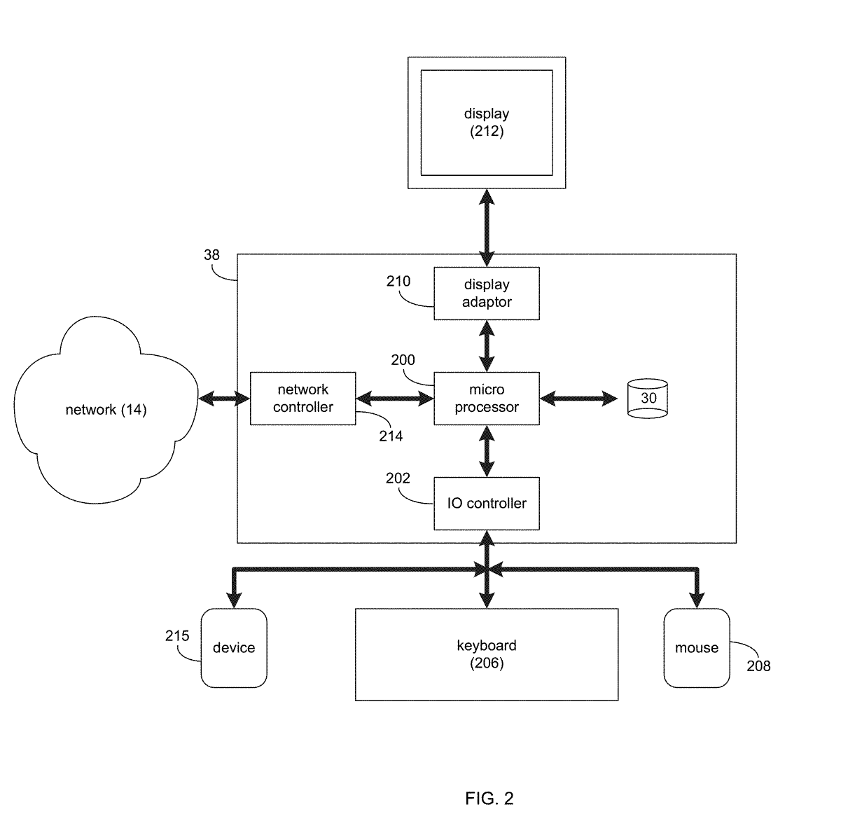

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, SC process 10 may be substituted for client electronic device 38 (in whole or in part) within FIG. 2, examples of which may include but are not limited to computer 12 and/or one or more of client electronic devices 40, 42, 44.

In some implementations, client electronic device 38 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

Generally, textual chat communications (e.g., instant messaging, chat rooms, text messaging, etc.) may be used to quickly and efficiently communicate with multiple people. In some situations, participants of, e.g., a chat group in a primary chat session, may wish to discuss what is transpiring in the primary chat session with a set of individuals that are not involved in the primary chat session. For instance, the individuals may wish to gather advice from friends on how to proceed in the chat session, they may wish for other members of their network or team to see the messages being exchanged for legal, quality assurance, training, etc. One example method for initiating a sidebar conversation with someone already in the primary chat session may be through “whisper mode” technology. Generally, “whisper mode” may only be possible with those who are already participants of the primary chat session. In “whisper mode,” a primary chat session user may be able to send a single private message to a targeted primary chat participant, and may be generally limited to communication manually entered (and/or cut/pasted) between two individuals. Additionally, in order for “whisper mode” senders and recipients to read such a message, the users may be required to open additional windows on top of the original primary chat session window, thus making scaling such efforts to multiple whisper chat sessions with multiple people difficult in terms of, e.g., navigation, operation, graphical real estate management, and coordination.

Users may also manually coordinate one of the participants of the primary chat session to open up a parallel chat session with someone else that is either part of the primary session or not. This may require manual coordination between two users, manual cut/paste operations, and/or manual navigation outside the primary chat session and into the parallel chat session, which may be in a separate window that may not be quickly accessible from the primary chat session. Typically, there may be limited or no mapping between a primary chat thread and the parallel chat thread. A possible consequence may be that the conversation in the primary chat session is not being viewed in real-time in the parallel chat session, which may result in a lack of context and/or lack of up-to-date context, which may further result in forwarded statements being misinterpreted without the proper context (e.g., which may come from a subsequent statement not yet viewable/forwarded to the parallel chat session). Thus, in this example, the individual in the parallel chat session that is not also involved in the primary chat session may not be able to adequately discuss what is transpiring in the primary chat session to give advice on how to proceed (e.g., what to say) in the primary chat session.

As will be discussed below, SC process 10 may at least help, e.g., improve network messaging technology necessarily rooted in computer technology in order to overcome an example and non-limiting problem specifically arising in the realm of computer networks and improve existing technological processes associated with, e.g., hidden messaging systems.

### The SC Process:

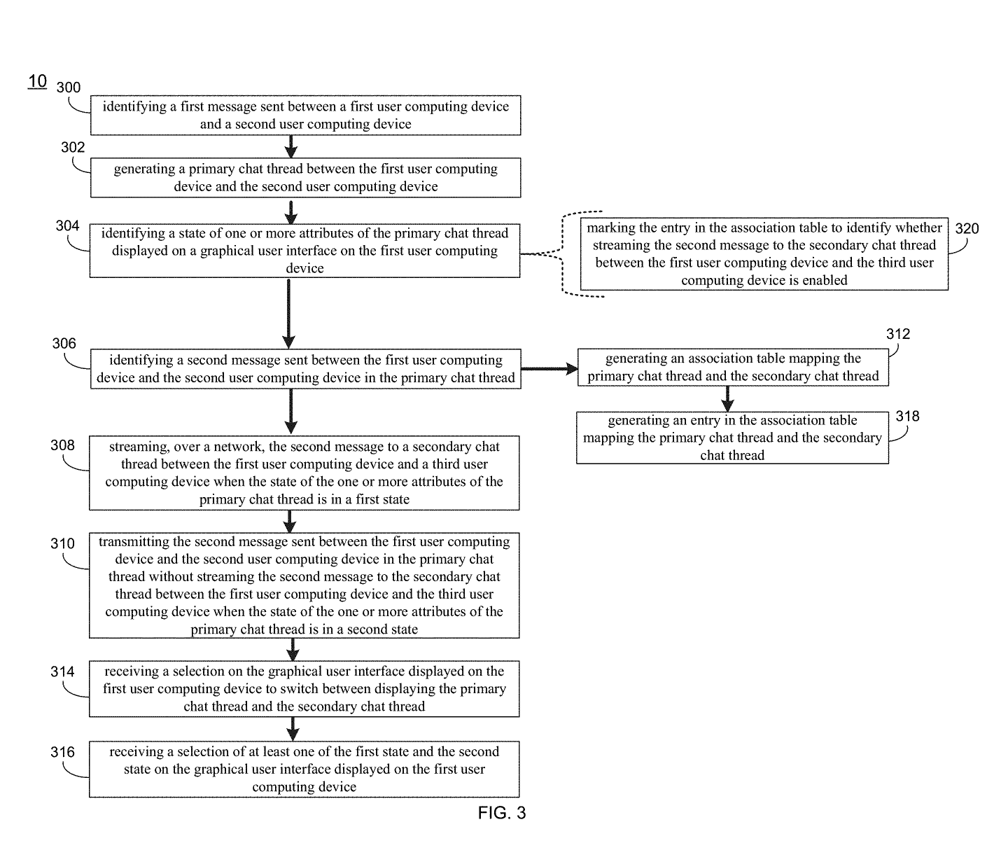

As discussed above and referring also at least to the example implementations of FIGS. 3-9, secondary chat (SC) process 10 may identify 300 a first message sent between a first user computing device and a second user computing device. SC process 10 may generate 302 a primary chat thread between the first user computing device and the second user computing device, wherein the primary chat thread may include the first message. SC process 10 may identify 304 a state of one or more attributes of the primary chat thread displayed on a graphical user interface on the first user computing device. SC process 10 may identify 306 a second message sent between the first user computing device and the second user computing device in the primary chat thread. SC process 10 may stream 308 the second message over a network to a secondary chat thread between the first user computing device and a third user computing device when the state of the one or more attributes of the primary chat thread is in a first state. SC process 10 may transmit 310 the second message sent between the first user computing device and the second user computing device in the primary chat thread without streaming the second message to the secondary chat thread between the first user computing device and the third user computing device when the state of the one or more attributes of the primary chat thread is in a second state.

While the following description involves a dating application used on a mobile client electronic computing device (e.g., smartphone), it will be appreciated that the present disclosure may be applied to any electronic messaging applications and any client electronic devices. As such, the description of a dating application and/or a smartphone should be used as example only and not to limit the scope of the disclosure.

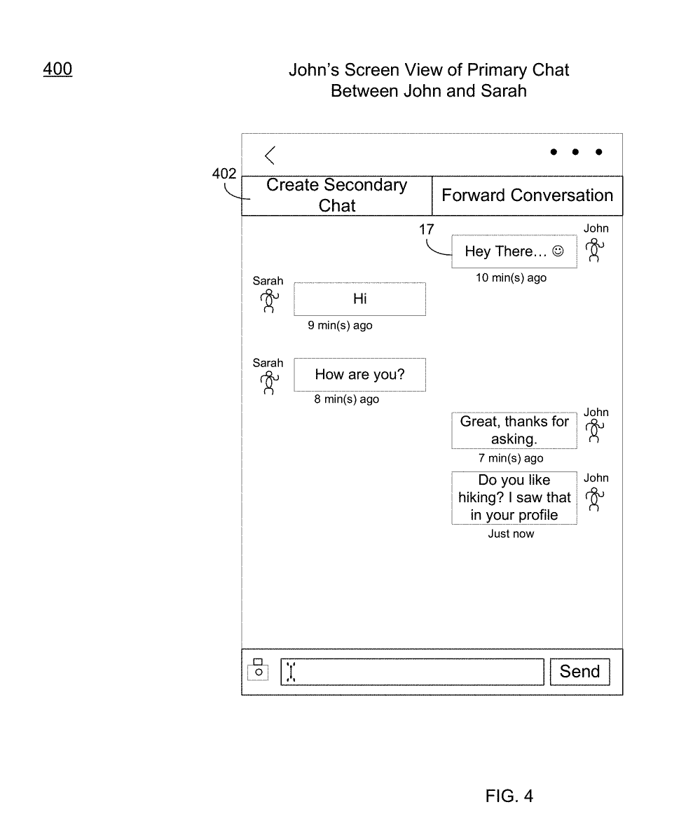

In some implementations, secondary chat (SC) process 10 may identify 300 a first message (e.g., message 17) sent between a first user computing device and a second user computing device. For instance, and referring at least to the example screen view 400 of FIG. 4, assume for example purposes only that a user (e.g., user 46), named John, is a member of a dating website. Further assume for example purposes only that another user (e.g., user 50), named Sarah, is a member of the dating website. Further assume that John wishes to start a dialogue with Sarah, and John sends Sarah a message (e.g., message 17). In the example, SC process 10 may identify 300 message 17 sent between John (via client electronic device 38) and Sarah (via client electronic device 42).

In some implementations, SC process 10 may generate 302 a primary chat thread between the first user computing device and the second user computing device, wherein the primary chat thread may include the first message. For example, a primary chat thread shown in screen view 400 may be generated 302 (e.g., via a user interface associated with SC process 10) to enable conventional message exchanges (e.g., IM chat) between John and Sarah (via their respective client electronic devices). As shown in screen view 400, message 17 sent between John (via client electronic device 38) and Sarah (via client electronic device 42) is included in the primary chat thread.

It will be appreciated that the user interface design shown in screen view 400 and other screen views may be changed. As such, the specific user interface design shown in screen view 400 and with other screen views should be taken as example only and not to otherwise limit the scope of the disclosure.

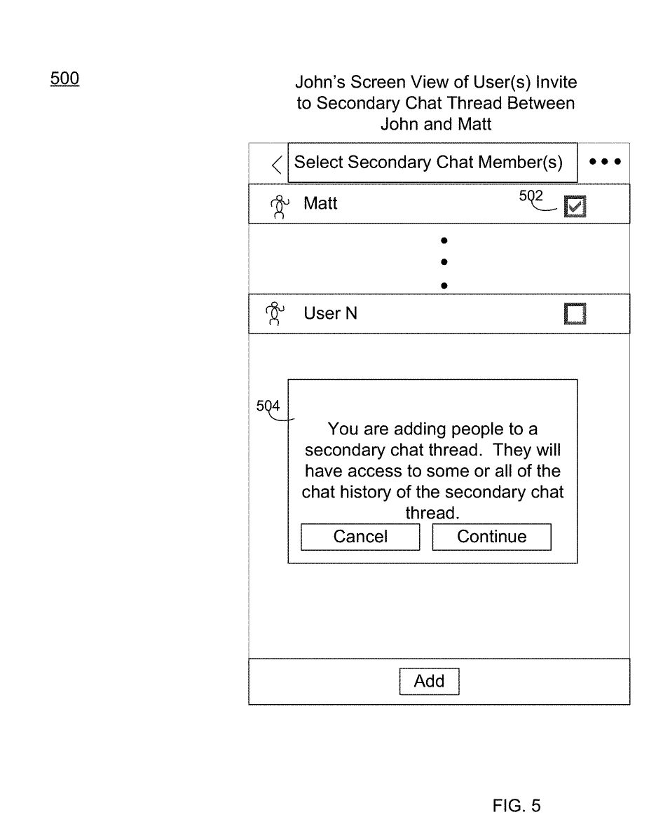

Further assume for example purposes only that at some point during the conversation in the primary chat thread, John decides he wants help knowing what to say to Sarah, by getting advice from another user (e.g., user 52), named Matt, who happens to be a friend of John's. In the example, John decides to share at least some messages of the primary chat thread with Matt (e.g., via client electronic device 44). In some implementations, John may select (e.g., via SC process 10) an object (e.g., object 402) shown in screen view 400 of the primary chat thread window object, which may result in screen view 500, shown in example FIG. 5. In the example, screen view 500 (e.g., via SC process 10) may enable John to select Matt (and/or other users) to be invited to participate in a secondary chat thread with John (e.g., via selecting object 502). In some implementations, a notification message (e.g., via pop-up window 504) may be displayed by SC process 10 to confirm John's decision to invite Matt to participate in the secondary chat thread. In the example, when confirmed, SC process 10 receives a request to generate a secondary chat thread, and may generate the secondary chat thread (e.g., as a child chat thread of the primary chat thread). In some implementations, John may similarly select (e.g., via SC process 10) an object on the screen view to remove Matt as a participant. In some implementations, John may (e.g., via SC process 10) select additional users to become participants of the secondary chat thread.

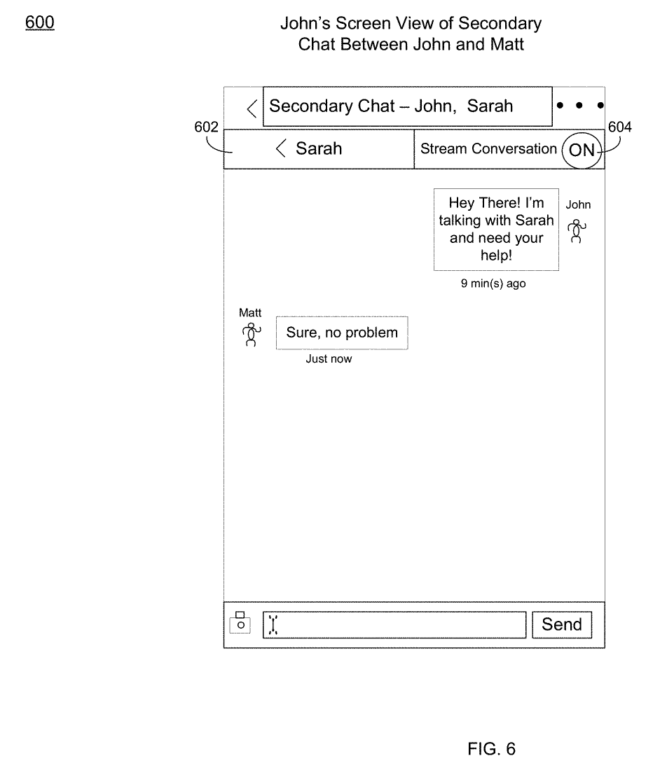

In some implementations, and referring at least to the example screen view 600 of FIG. 6, John may (via SC process 10) send Matt a message in the secondary chat thread asking for Matt's advice on the conversation going on between John and Sarah in the primary chat thread. In the example, Matt may (via SC process 10) exchange messages with John in the secondary chat thread, which is not seen in the primary chat thread.

In some implementations, SC process 10 may receive 314 a selection on the graphical user interface displayed on the first user computing device to switch between displaying the primary chat thread and the secondary chat thread. For example, John may (via SC process 10) switch back and forth between the secondary chat thread and the primary chat thread by selecting an object (e.g., object 602). In the example, SC process 10 may receive 314 the selection (e.g., of object 602) to switch between displaying the primary chat thread and the secondary chat thread. In some implementations, switching back and forth may be accomplished using other techniques (e.g., click, toggle, tap, swipe or other gesture, etc.).

In some implementations, to switch back and forth between the primary and secondary chat threads, John may (e.g., via SC process 10 receiving 314 a selection on the graphical user interface) go out to a messages list, go into the secondary chat thread, and do the same in reverse to get back to the primary chat thread.

In some implementations, SC process 10 may identify 304 a state of one or more attributes of the primary chat thread displayed on a graphical user interface on the first user computing device. For instance, assume for example purposes only that John now wishes to have the messages between John and Sarah sent (e.g., streamed) in the primary chat thread to the secondary chat thread. In some implementations, SC process 10 may receive 316 a selection of at least one of the first state and the second state on the graphical user interface displayed on the first user computing device. In the example, John may select (via SC process 10) an object (e.g., object 604) on the graphical user interface of client electronic device 38. As will be discussed in greater detail, in the example, selecting object 604 may result in, e.g., an “on” or “off” state (or similar state) of an attribute of the primary chat thread, which may be identified 304 by SC process 10 to determine whether to stream messages from the primary chat thread to the secondary chat thread. In some implementations, switching states may be accomplished using other techniques (e.g., click, toggle, tap, swipe or other gesture, etc.). In some implementations, object 604 may be shown via the primary chat thread view.

In some implementations, the first state may be specific to the user. For example, John may have his primary chat thread in the first state, while Sarah may have her primary chat thread in the second state. Thus, in the example, John may be streaming messages in his primary chat thread to his secondary chat thread, where Sarah may not be streaming her messages to her secondary chat thread.

As will be discussed below, SC process 10 may generate 312 an association table mapping the primary chat thread and the secondary chat thread. In some implementations, identifying 304 the state of the one or more attributes of the primary chat thread displayed on the graphical user interface on the first user computing device may include SC process 10 marking 320 the entry in the association table to identify whether streaming the second message to the secondary chat thread between the first user computing device and the third user computing device is enabled. For example, SC process 10 may record/update the state of the above-noted attribute for whether or not streaming is on or off for the secondary chat thread (in the example “stream_on” column of association table 700a), which may be used by SC process 10 for the above-noted attribute state identification 304.

In some implementations, since SC process 10 may enable John (who via SC process 10 generated the primary chat thread) with configurable settings that generated the secondary chat session, John may be considered generally as a secondary chat thread administrator and/or owner.

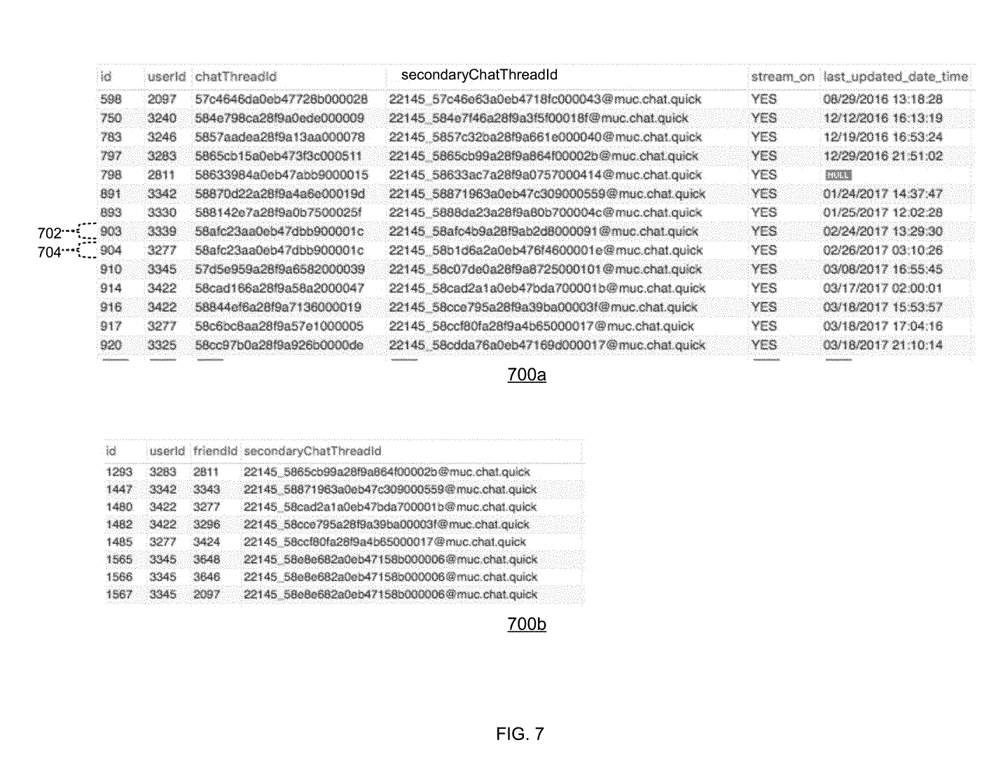

In some implementations, SC process 10 may generate 312 an association table mapping the primary chat thread and the secondary chat thread. For example, and referring at least to the example association table 700a in FIG. 7 generated 312 by SC process 10, SC process 10 may map (e.g., link) the secondary chat thread to the primary chat thread by way of a data layer that may hold the association data. For instance, in some implementations, the primary chat thread may be generated 302 first by SC process 10, and may be recorded in the above-noted datastore by SC process 10. An association table may also be known as, e.g., a bridge table, a cross-reference table, a crosswalk, an intermediary table, an intersection table, a join table, a junction table, a link table, a linking table, a many-to-many resolver, a map table, a mapping table, a pairing table, a pivot table or transition table. In some implementations, primary chat threads may exist between two or more users. In some implementations, as noted above, once the primary chat thread is generated 302, anyone participating in the primary chat thread may generate (via SC process 10) a secondary chat thread that is a subsidiary of the primary chat thread. While the disclosure describes an association table, it will be appreciated that other techniques to map the secondary chat thread to the primary chat thread may be used without departing from the scope of the disclosure.

In some implementations, SC process 10 may generate 318 an entry in the association table mapping the primary chat thread and the secondary chat thread. For example, once the above-noted request to generate a secondary chat thread is received by SC process 10, SC process 10 may generate 318 an entry (e.g., entry 702) in the association table that maps (associates) this secondary chat thread with the primary chat thread. In some implementations, a primary chat thread identifier may be assigned to the primary chat thread by SC process 10, and may be stored in an example “chatThreadId” column of association table 700a. In some implementations, any secondary chat threads off of the primary chat thread may be recorded by SC process 10 in an example “secondaryChatThreadId” column of the association table (e.g., in the associated entry). In some implementations, SC process 10 may assign and record a user ID of the user (e.g., John and/or Sarah) that started the secondary chat thread (e.g., John in the above example) in the example “userId” column of association table 700a.

In some implementations, SC process 10 may enable generation of more than one secondary chat thread off of a single primary chat thread. For example, SC process 10 may generate a secondary chat thread for John (shown in entry 702) and a separate secondary chat thread for Sarah (shown in entry 704). In the example, it may be seen that the association table includes chatThreadId “58afc23aa0eb47dbb900001c” and two secondary chat thread generated entries (702 and 704). In the example, each secondary chat thread entry may have a different “userId” value assigned and recorded by SC process 10, where the “userId” denotes the user that requested generation of the secondary chat thread. In the example, entry 702 may be used by SC process 10 to map the primary chat thread to John's secondary chat thread, and entry 704 may be used by SC process 10 to map that same primary chat thread to Sarah′ secondary chat thread. In some implementations, in the above example, each of John's and Sarah′ secondary chat threads may be unique secondary chat threads and may occur simultaneously, where each has no knowledge of the other.

In some implementations, SC process 10 may similarly enable Matt to create a secondary chat thread off of John's secondary chat thread. In some implementations, SC process 10 may generate a secondary chat thread for John (e.g., participating with Matt) and a separate secondary chat thread for John (e.g., participating with Matt and/or other users), thus creating a dependency structure that may span multiple parent/child levels. For example, and referring at least to the example association table 700b in FIG. 7 generated 312 by SC process 10, the linking of secondary chat threads to the participants that the secondary chat creator (e.g., Matt) has invited in may be accomplished similarly as noted in association table 700a (e.g., a data layer that may hold the association data). Upon creating the secondary chat thread, the secondary chat creator (e.g., Matt) may (via SC process 10) invite one or more participants to join the chat with him. In some implementations, this association of participants to the secondary chat thread may be stored in a separate association table, or may be part of association table 700a. In the example association table 700b, three columns are populated. (1) “UserId,” which may be the secondary chat thread creator's user id, (2) “friendId,” which may be the participant user id, and (3) “secondaryChatThreadId,” which may be the thread id of the secondary chat thread that the participant has been invited into. In some implementations “userId” may be listed in association table 700b for convenience, and may not be needed to provide the mapping. In some implementations, the information in association table 700b combined with information from other association tables (e.g., association table 700a) may enable SC process 10 to map the information about primary chats, secondary chats, creators of secondary chats, whether streaming is on/off, and the participants that are involved.

It will be appreciated that association table 700a and/or association table 700b may include more or less (and different) field columns without departing from the scope of the disclosure. As such, association table 700a and/or association table 700b should be taken as example only and not to limit the scope of the disclosure.

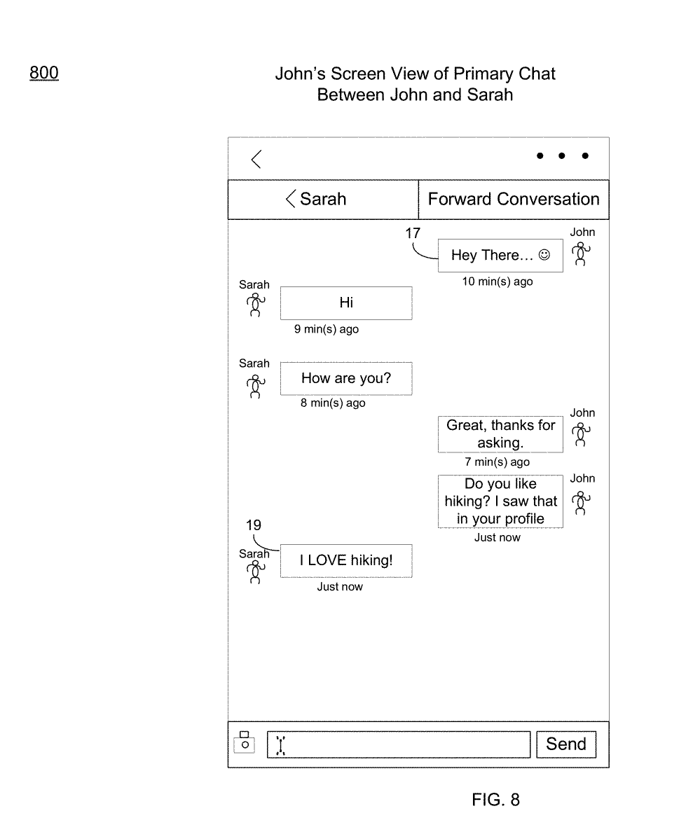

In some implementations, SC process 10 may identify 306 a second message (e.g., message 19) sent between the first user computing device and the second user computing device in the primary chat thread. For instance, and referring at least to the example screen view 800 of FIG. 8, a new message (e.g., message 19) has been sent by Sarah to John, which may be identified 306 by SC process 10.

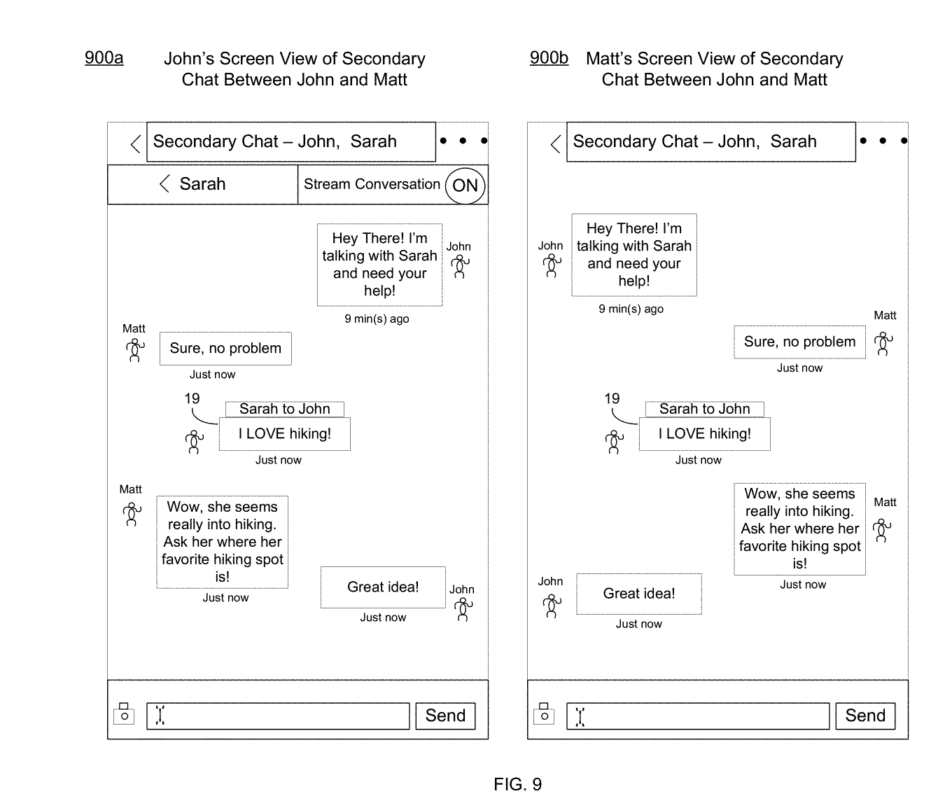

In some implementations, SC process 10 may stream 308 the second message over a network to the secondary chat thread between the first user computing device and a third user computing device when the state of the one or more attributes of the primary chat thread is in a first state. For instance, and referring at least to the example screen views 900a (showing John's screen view of secondary chat thread between John and Matt) and 900b (showing Matt's screen view of secondary chat thread between John and Matt) of FIG. 9, SC process 10 has streamed 308 (e.g., in real-time) message 19 to the secondary chat thread between John and Matt, since message 19 (or any message) was identified 306 as sent (and/or received) between Sarah and John when the state of the primary chat thread was in the “on” state. In the example, since Matt and John are participants in the secondary chat thread able to view any messages being streamed 308 from the primary chat thread to the secondary chat thread, Matt and John may exchange messages between one another about any messages being streamed 308 from the primary chat thread to the secondary chat thread, as a result of those messages being sent (and/or received) between Sarah and John when the state of the primary chat thread was in the “on” state. For instance, Matt may read the streamed messages (e.g., message 19) and provide advice on how John should respond. In some implementations, because the secondary chat thread members may not know what other participants are in the primary chat thread, messages that are exchanged in the primary chat thread while streaming is turned on may be presented to the members of the secondary chat thread with a label (e.g., “Sarah to John”) to indicate who was speaking and to whom the message was intended if known. In some implementations, SC process 10 may hide the identity of any member of the primary chat thread. For example, the “Sarah to John” label may be changed to “Alias to John” or “‘User’ to John”. In some implementations, when there are multiple people in the primary chat thread and someone says something to the whole group, but it is not necessarily known who it is specifically for, the label may be changed to, e.g., “Sarah to Everyone”, “Sarah to Group”, etc.

It will be appreciated that the identified 306 message 19 may be a message sent by John to Sarah or sent by Sarah to John without departing from the scope of the disclosure. For example, John may send message 19 to Sarah, which may also get streamed to John's secondary chat thread. As such, the description of message 19 being sent by Sarah to John should be taken as example only and not to limit the scope of the disclosure.

In some implementations, SC process 10 may transmit 310 the second message sent between the first user computing device and the second user computing device in the primary chat thread without streaming the second message to the secondary chat thread between the first user computing device and the third user computing device when the state of the one or more attributes of the primary chat thread is in a second state. For instance, assume for example purposes only that instead of message 19 being identified 306 as sent (and/or received) when the state of the primary chat thread was in the “on” state, that message 19 was identified 306 as sent when the state of the primary chat thread was in the “off” state. In the example, since message 19 was identified 306 as sent when the state of the primary chat thread was in the “off” state, SC process 10 may transmit 310 message 19 only to the primary chat thread, and without also streaming message 19 to the secondary chat thread. As a result, Matt's screen view of the secondary chat between John and Matt (900b) would not display message 19. In some implementations, John may (via SC process 10) switch the state of streaming on/off at any point during the primary chat thread. In some implementations, John may (via SC process 10) individually select messages in the primary chat thread to be forwarded to the secondary chat thread, even after message 19 is identified 306 as sent (and/or received) when the state of the primary chat thread was in the “off” state. In some implementations, even though the primary chat thread is in the first state (on), SC process 10 may still confirm with John whether or not he wishes to stream each particular message.

In some implementations, the second user computing device may be a non-participant in the secondary chat thread and wherein the third user computing device may be a non-participant in the primary chat thread. For instance, in the example, Sarah is not a participant of John's secondary chat thread with Matt, and Matt is not a participant of John's primary chat thread with Sarah. Thus, in the example, even though Matt is not a participant in the primary chat thread, Matt may still be a participant in the secondary chat thread to receive messages from the primary chat thread (streaming or otherwise), but may not see the primary chat thread itself or send messages in the primary chat thread (e.g., unless Matt were subsequently added as a participant to the primary chat thread by John or Sarah). Similarly, because Sarah is not a participant in the secondary chat thread, Sarah may not see any of the messages in the secondary chat thread (or the secondary chat thread itself), whereby the secondary chat thread may be unseen to Sarah.

In some implementations, at least since the messages may be streamed (when appropriate) in real-time using the above-noted association table, Matt may be able to provide John with the appropriate advice with the proper context and/or up-to-date context of the primary chat thread.

It will be appreciated that message 19 may include text, image, and/or video. As such, the description of message 19 as being text should be taken as example only.

In some implementations, SC process 10 may enable messaging to span across different messaging technology stacks (e.g., where SC process 10 has access to each and may reach users on each). For example, John may (e.g., via SC process 10) create a secondary chat while inside a first client application, and may pick out contacts on John's phone instead of users in the first client application, and SC process 10 may itself stream the messages into the first client application chat thread and via, e.g., SMS. Thus, in the example, SC process 10 may stream message 19 to the secondary chat thread, and also send off a SMS text message to the contact that John identified via SMS. In the example, when John sends a message to the secondary chat thread, SC process 10 may identify that and send that message not only to the secondary chat thread but also over that SMS link. In some implementations, any messages that another user sends back to that SMS number that is (e.g., via SC process 10) facilitating the secondary chat thread, gets routed to the SC process, which may identify it as coming from a number that is tagged for inclusion in the secondary chat thread, and may display that same message into the secondary chat thread itself, which may show up in the first client application.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying a first message sent between a first user computing device and a second user computing device;
generating a primary chat thread between the first user computing device and the second user computing device, wherein the primary chat thread includes the first message;
identifying a state of one or more attributes of the primary chat thread displayed on a graphical user interface on the first user computing device;
identifying a second message sent between the first user computing device and the second user computing device in the primary chat thread;
streaming, over a network, the second message to a secondary chat thread between the first user computing device and a third user computing device when the state of the one or more attributes of the primary chat thread is in a first state; and
transmitting the second message sent between the first user computing device and the second user computing device in the primary chat thread without streaming the second message to the secondary chat thread between the first user computing device and the third user computing device when the state of the one or more attributes of the primary chat thread is in a second state.

2. The computer-implemented method of claim 1 further comprising receiving a selection of at least one of the first state and the second state on the graphical user interface displayed on the first user computing device.

3. The computer-implemented method of claim 1 wherein the second user computing device is a non-participant in the secondary chat thread and wherein the third user computing device is a non-participant in the primary chat thread.

4. The computer-implemented method of claim 1 further comprising receiving a selection on the graphical user interface displayed on the first user computing device to switch between displaying the primary chat thread and the secondary chat thread.

5. The computer-implemented method of claim 1 further comprising generating an association table mapping the primary chat thread and the secondary chat thread.

6. The computer-implemented method of claim 5 further comprising generating an entry in the association table mapping the primary chat thread and the secondary chat thread.

7. The computer-implemented method of claim 6 wherein identifying the state of the one or more attributes of the primary chat thread displayed on the graphical user interface on the first user computing device includes marking the entry in the association table to identify whether streaming the second message to the secondary chat thread between the first user computing device and the third user computing device is enabled.

8. A computer program product residing on a computer readable storage medium having a plurality of instructions stored thereon which, when executed across one or more processors, causes at least a portion of the one or more processors to perform operations comprising:
identifying a first message sent between a first user computing device and a second user computing device;
generating a primary chat thread between the first user computing device and the second user computing device, wherein the primary chat thread includes the first message;
identifying a state of one or more attributes of the primary chat thread displayed on a graphical user interface on the first user computing device;
identifying a second message sent between the first user computing device and the second user computing device in the primary chat thread;
streaming, over a network, the second message to a secondary chat thread between the first user computing device and a third user computing device when the state of the one or more attributes of the primary chat thread is in a first state; and
transmitting the second message sent between the first user computing device and the second user computing device in the primary chat thread without streaming the second message to the secondary chat thread between the first user computing device and the third user computing device when the state of the one or more attributes of the primary chat thread is in a second state.

9. The computer program product of claim 8 wherein the operations further comprise receiving a selection of at least one of the first state and the second state on the graphical user interface displayed on the first user computing device.

10. The computer program product of claim 8 wherein the second user computing device is a non-participant in the secondary chat thread and wherein the third user computing device is a non-participant in the primary chat thread.

11. The computer program product of claim 8 wherein the operations further comprise receiving a selection on the graphical user interface displayed on the first user computing device to switch between displaying the primary chat thread and the secondary chat thread.

12. The computer program product of claim 8 wherein the operations further comprise generating an association table mapping the primary chat thread and the secondary chat thread.

13. The computer program product of claim 12 wherein the operations further comprise generating an entry in the association table mapping the primary chat thread and the secondary chat thread.

14. The computer program product of claim 13 wherein identifying the state of the one or more attributes of the primary chat thread displayed on the graphical user interface on the first user computing device includes marking the entry in the association table to identify whether streaming the second message to the secondary chat thread between the first user computing device and the third user computing device is enabled.

15. A computing system including one or more processors and one or more memories configured to perform operations comprising:
identifying a first message sent between a first user computing device and a second user computing device;
generating a primary chat thread between the first user computing device and the second user computing device, wherein the primary chat thread includes the first message;
identifying a state of one or more attributes of the primary chat thread displayed on a graphical user interface on the first user computing device;
identifying a second message sent between the first user computing device and the second user computing device in the primary chat thread;
streaming, over a network, the second message to a secondary chat thread between the first user computing device and a third user computing device when the state of the one or more attributes of the primary chat thread is in a first state; and
transmitting the second message sent between the first user computing device and the second user computing device in the primary chat thread without streaming the second message to the secondary chat thread between the first user computing device and the third user computing device when the state of the one or more attributes of the primary chat thread is in a second state.

16. The computing system of claim 15 wherein the operations further comprise receiving a selection of at least one of the first state and the second state on the graphical user interface displayed on the first user computing device.

17. The computing system of claim 15 wherein the second user computing device is a non-participant in the secondary chat thread and wherein the third user computing device is a non-participant in the primary chat thread.

18. The computing system of claim 15 wherein the operations further comprise receiving a selection on the graphical user interface displayed on the first user computing device to switch between displaying the primary chat thread and the secondary chat thread.

19. The computing system of claim 15 wherein the operations further comprise generating an association table mapping the primary chat thread and the secondary chat thread.

20. The computing system of claim 19 wherein the operations further comprise generating an entry in the association table mapping the primary chat thread and the secondary chat thread.

21. The computing system of claim 20 wherein identifying the state of the one or more attributes of the primary chat thread displayed on the graphical user interface on the first user computing device includes marking the entry in the association table to identify whether streaming the second message to the secondary chat thread between the first user computing device and the third user computing device is enabled.
